(19) United States
(12) Patent Application Publication
(10) Pub. No.: US 2008/0005119 A1
(43) Pub. Date: Jan. 3, 2008

(54) REMOTELY UPDATING A USER STATUS ON A PRESENCE SERVER

(76) Inventors: Christopher L. Fernandez, Aurora, IL (US); Cynthia K. Florkey, Chicago, IL (US); Kevin J. Overend, Elmhurst, IL (US)

Correspondence Address: DUFT BORNSEN & FISHMAN, LLP, 1526 SPRUCE STREET, SUITE 302, BOULDER, CO, 80302, US

(21) Appl. No.: 11/427,708

(22) Filed: Jun. 29, 2006

(51) Int. Cl. G06F 17/30

(52) U.S. Cl. 707/10

(57) ABSTRACT

Systems and methods are disclosed to remotely update the user status of a user on a presence server. Assume that a communication server provides a communication service to a client device operating a client application, and a presence server coupled to the communication server monitors the user status. In one embodiment of the invention, a status updating system comprises an interface system adapted to receive a request to update the user status on the presence server from a communication device not operating the client application. The status updating system further comprises a processing system coupled to the interface system that is adapted to identify a user identifier of the user for the communication service on the presence server in response to the request, and to transmit an update message to the presence server to update the user status for the communication service indicated by the user identifier.

### BACKGROUND

1. Field of the Invention

The invention relates generally to the field of communications, and particularly to methods and systems for remotely updating a user status on a presence server.

2. Statement of the Problem

In computer and telecommunication networks, presence information conveys a user's availability and willingness to communicate. A client application publishes presence information to other users on a network to convey a communication state. One particular application of presence information involves instant messaging systems. Instant messaging systems allow a user of a computing device operating a client application to send a message over a network to another user also online at the same time and operating a similar client application. With instant messaging, the user inputs information of other users into a presence list in the client application, which is typically known as a “Friends List”. When any of those individuals on the “Friends List” logs into the network using the client application, the user is notified of their presence on the network, and has the option of commencing an interactive chat session using the client application.

Instant messaging servers maintain a user status of a user that can be updated or changed through the client application. The user status specifies the user's availability for communication. When the user first logs into the instant messaging server, the client application running on the user's computer automatically sets the user status to “on-line”.

Many client applications allow the user to manually change the user status. For instance, if the user desires to step away from the computer momentarily, then the user status can be changed to “unavailable” to notify others that the user is temporarily unavailable.

One problem with these types of systems is that the user status can only be changed through the client application presently logged into the instant messaging server. For example, assume that a user is away from the computer and realizes that the user status is presently set to “on-line”. If the user desires to change the user status from “on-line” to “away from desk” or “unavailable”, then the user would have to return to the computer and change the user status manually through the client application. Depending on the location of the user, returning to the computer to update the user status of an instant messaging client may be impracticable and time consuming.

### SUMMARY OF THE SOLUTION

The invention solves the above problems and other problems with systems and methods for remotely updating a user status on a presence server through a remote communication device (e.g., mobile phone, PDA, etc). When a client application on a client device (e.g., a computer) is logged into a communication server (e.g., an instant messaging server), the presence server coupled to the communication server monitors the user status. According to features and aspects herein, the user may use a communication device (e.g., a phone) that is not running the client application to update the user status on the presence server. A user no longer needs to return to his or her computer and access the presence server through the client application in order to change the user status. The user can advantageously update the user status on the presence server from virtually any location.

One embodiment of the invention comprises a status updating system adapted to update a user status on a presence server. A communication server is adapted to provide a communication service, such as an instant messaging service, to a client application of the user operating on a client device and a presence server coupled to the communication server monitors the user status of the user for the communication service. The status updating system comprises an interface system adapted to receive a request to update the user status on the presence server from a communication device not operating the client application. For instance, the client device operating the client application may be a PC of a user, while the communication device not operating the client application may comprise a cell phone of the user. The status updating system further comprises a processing system coupled to the interface system that is adapted to identify a user identifier for the user on the presence server in response to the request, and to transmit an update message to the presence server to update the user status on the presence server based on the user identifier.

Another embodiment of the invention comprises a method for updating a user status on a presence server coupled to a communication server that provides a communication service to a client device operating a client application, wherein the presence server monitors the user status of the user for the communication service. The method comprises the steps of receiving a request to update the user status on the presence server from a communication device not operating the client application, identifying a user identifier of the user for the communication device, and transmitting an update message to the presence server to update the user status on the presence server based on the user identifier.

The invention may include other exemplary embodiments described below.

### DESCRIPTION OF THE DRAWINGS

The same reference number represents the same or similar element on all drawings.

FIG. 1 illustrates a status updating system for remotely updating a user status on a presence server in an exemplary embodiment of the invention.

FIG. 2 is a flow chart illustrating a method for remotely updating a user status on a presence server in an exemplary embodiment of the invention.

FIG. 3 illustrates a status updating system for remotely updating a user status on a presence server in another exemplary embodiment of the invention.

FIG. 4 is a flow chart illustrating a method for remotely updating a user status on a presence server in another exemplary embodiment of the invention.

FIG. 5 is a flow chart illustrating a method for remotely updating a user status on a presence server in another exemplary embodiment of the invention.

### DETAILED DESCRIPTION OF THE INVENTION

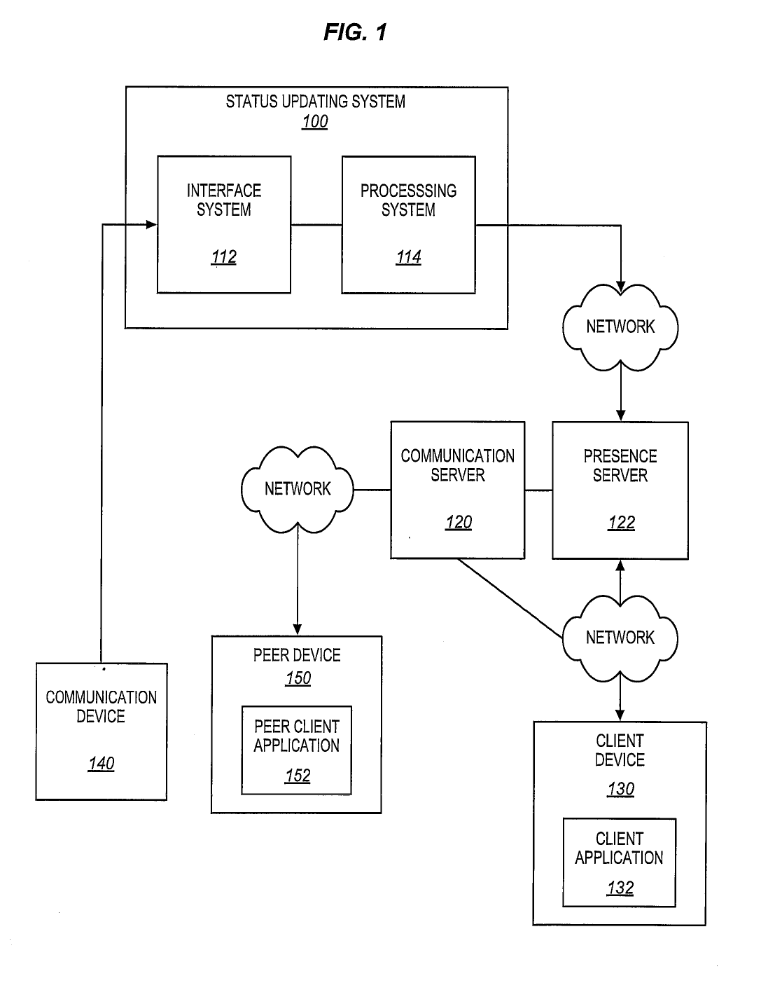

FIGS. 1-5 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a status updating system 100 for remotely updating a user status on a presence server 122 in an exemplary embodiment of the invention. A communication server 120 is adapted to provide a communication service, such as an instant messaging service, over a network to a client application 132 operating on a client device 130. The communication server 120 is coupled to the presence server 122, and the presence server 122 is adapted to monitor the user status of the user (not shown) of the client device 130 for the communication service. The user status may be any message adapted to communicate to peer users the user's willingness or availability to communicate.

The status updating system 100 communicates with the presence server 122 over a network to update the user status of the user on the presence server 122. The status updating system 100 comprises an interface system 112 and a processing system 114. The interface system 112 is provided in the status updating system 100 to allow the user to interface with the status updating system 100 through a communication device 140. The processing system 114 coupled to the interface system 112 is provided in the status updating system 100 to process requests from the user using the client device 140 to update the user status on presence server 122.

The communication server 120 comprises any system, server or device that provides the communication service, such as an instant messaging service, through a network to the client device 130. The client device 130 operates the client application 132 to receive the communication service from the communication server 120. For example, the client device 130 may be a PC, and the client application 132 may be an instant messaging application. The presence server 122 monitors the user status, and may publish the user status to peer users through a peer device 150. A communication service enables an individual to communicate with one or more other individuals through a client device, such as a computer, a PDA, a telephone, etc. Examples of communication services include instant messaging, chat systems, online gaining systems, etc.

The user status on the presence server 122 is traditionally changed through the client application 132. For instance, when the user initially logs into the communication server 120 through client device 130, the user status on the presence server 122 may be set to “on-line”. The client application 132 may be adapted to allow the user to manually change the user status after the initial login. For instance, when the user leaves the client device 130, the user may manually change the user status through the client application 132 to “away from desk.”

The peer device 150 accesses the communication server 120 and the presence server 122 through a network utilizing a peer client application 152, and may receive a communication service from the communication server 120. The peer client application 152 may be a similar software application to the client application 132. For example, peer client application 152 and client application 132 may both be instant messaging applications. Further, the peer client application 152 and the client application 132 may be receiving the same or a similar communication service from the communication server 120. When the user status changes on the presence server 122, the peer user may receive an updated user status of the user through the peer client application 152.

If the user leaves the client device 130 operating the client application 132, he or she may forget to manually change the user status on the presence server 122 to show an unavailability to communicate with peer users utilizing the peer client application 152. For example, the user may leave his or her office to attend a meeting. If peer users attempt to communicate with the user through communication server 120, an immediate response from the user may not be forthcoming. To avoid the situation previously described, the user may want to remotely update the user status on the presence server 122 to reflect the unavailability to communicate with other users through the communication server 120. The user may use communication device 140, which may not be operating the client application 132, to access the status updating system and remotely update the user status on the presence server 122.

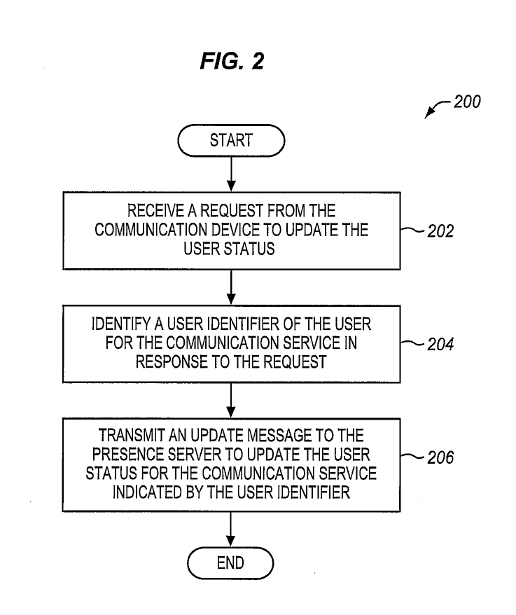

FIG. 2 is a flow chart illustrating a method 200 for remotely updating a user status on a presence server 122 in an exemplary embodiment of the invention. The steps of method 200 will be described with reference to FIG. 1. The steps of the flow chart in FIG. 2 are not all inclusive and may include other steps not shown.

In step 202, the interface system 112 receives the request to update the user status on the presence server 122 from the user using the communication device 140. The communication device 140 may comprise any communication device adapted to transmit a message. Exemplary devices include a phone adapted to provide a phone call, a mobile phone or PDA adapted to provide a text message, or a computer, PDA or web-enabled phone adapted to receive a web page or other internet service from an internet server.

In step 204, the processing system 114 identifies a user identifier for the user on the communication server 120. The user identifier may comprise a username, a password, a pin number or some other information identifying the communication service for the user on the communication server 120. The processing system 114 may identify the user identifier by prompting the user to provide the user identifier. If the communication server 120 and presence server 122 are not part of the core network comprising the status updating system 100, then the user identifier may further identify the identity and/or location of the presence server 122. For example, the user identifier may comprise a username and domain address.

In step 206, the processing system 114 transmits an update message to the presence server 122 instructing the presence server 122 to update the user status for the communication service indicated by the user identifier. The update message may be any message adapted to instruct the presence server 122 to update the user status. The update message may additionally comprise authorization credentials, such as a username and/or a password, to authenticate the user of the communication device 140 to the presence server 122. In response to receiving the update message, the presence server 122 may update the user status to reflect the specified updated user status in the request to the status updating system 100.

The status updating system 100 may further be adapted to receive a selection of a status change through the interface system 112 from the user of the communication device 140, and transmit the update message to the presence server 122 to update the user status based upon the selection from the user. For instance, the user may use communication device 140 to enter a numerical selection indicating a status change to “unavailable”, “away from desk”, etc. In response to the presence server 122 receiving the update message, the user status of the user may be updated. Peer users may receive the updated user status of the user.

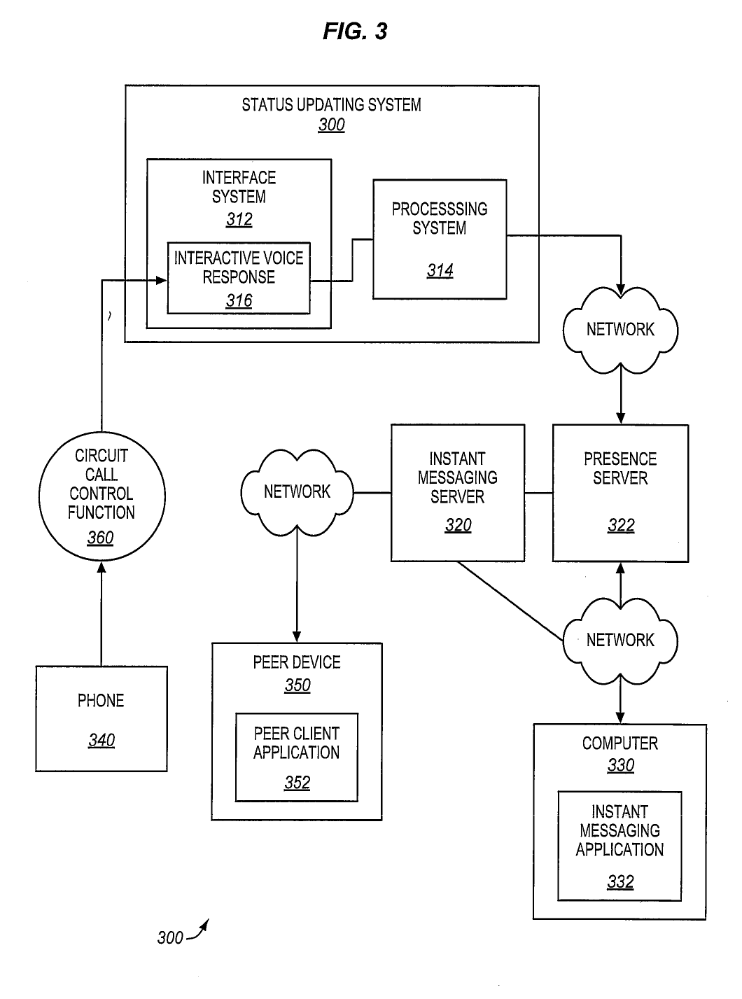

FIG. 3 illustrates a status updating system 300 for remotely updating a user status on a presence server 322, wherein the user status comprises an instant messaging status, in another exemplary embodiment of the invention. The instant messaging server 320 provides an instant messaging service over a network to a computer 330 operating an instant messaging application 332. The computer 330 alternatively may be any computing device (e.g., a PDA or mobile phone) capable of operating the instant messaging application 332. A presence server 322 coupled to the instant messaging server 320 is adapted to monitor the instant messaging status of the user using the instant messaging application 332.

The status updating system 300 communicates with the communication server 320 over a network. The status updating system 300 comprises an interface system 312 and a processing system 314. The interface system 312 further comprises an interactive voice response system 316 provided to interface with a communication device, such as a phone 340. The status updating system 300 further comprises a processing system 314 coupled to the interface system 312 to remotely update the user status of the user on presence server 322. In the described embodiment in FIG. 3, the instant messaging server 320 and presence server 322 are not part of the core network comprising the status updating system 300, and may be operated by a third party. The status updating system 300 is adapted to remotely update the user status on the presence server 322 operated by a third party vendor.

Assume for example that a user has been logged in to his or her instant messaging account through the instant messaging client 332 running on the computer 330. The instant messaging status of the user is presently “on-line” indicating that the user is available to receive instant messaging messages. Assume further that the user leaves the proximity of the computer 330 without changing his or her instant messaging status to reflect an unavailability to communicate. If the user desires to update his or her instant messaging status, then the user would traditionally have to do so through the computer 330. According to features and aspects herein, the user can remotely update his or her instant messaging status through virtually any communication device that is not operating the instant messaging application 332. “Remotely update” refers to updating the instant messaging status through a device other than the computer 330 that is operating the instant messaging application 332, such as a cell phone, a telephone, etc. For instance, if the user leaves the computer 330 for a meeting, then the user may use the phone 340 found in the meeting room to remotely update his or her instant messaging status.

In the described embodiment in FIG. 3, the user uses the phone 340 to place a call to the status updating system 300 to remotely update his or her instant messaging status. A circuit call control function 360 receives the call to the status updating system 300, and routes the call to the interactive voice response system 316. In response to receiving a phone call from the phone 340, the status updating system 300 may first authenticate the user of the phone 340. In an alternative to placing a call to the status updating system 300, the user may use phone 340 to send a text message to the status updating system 300 with a feature code to change the user status.

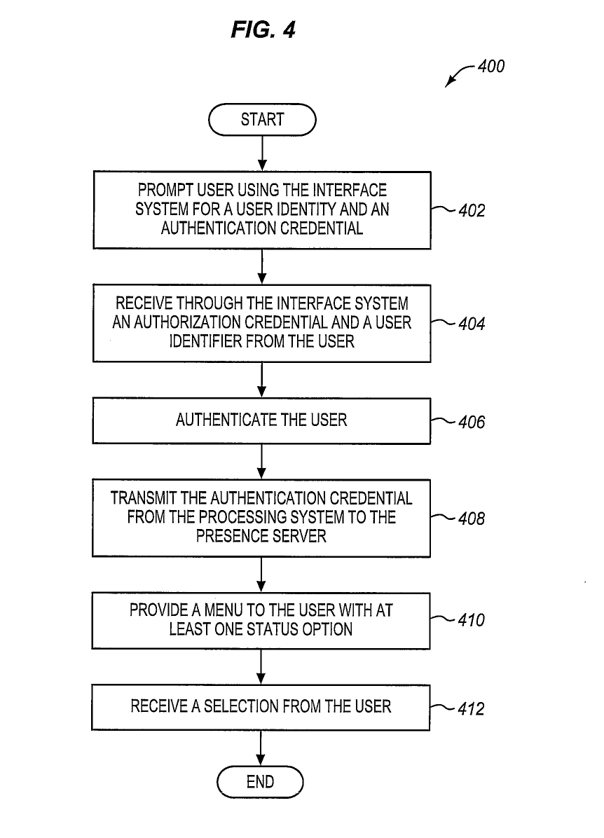

FIG. 4 is a flow chart illustrating a method 400 for authenticating a user desiring to remotely update an instant messaging status on the presence server 322 in an exemplary embodiment of the invention. The steps of method 400 will be described with reference to FIG. 3. The steps of the flow chart in FIG. 4 are not all inclusive and may include other steps not shown.

In step 402, the interface system 312 prompts the user of phone 340 for an instant messaging identifier and an authentication credential. For example, the prompt may come from the interactive voice response system 316. The instant messaging identifier may be used to identify the user's instant messaging account on the instant messaging server 320 and the presence server 322. The authentication credential may be used to authenticate the user of the phone 340 to the instant messaging server 320 and/or the presence server 322. Additionally, the authentication credential may be used to authenticate the user of the phone 340 to the status updating system 300. For instance, the instant messaging identifier is a username that the user typically enters to access the instant messaging server 320, such as jdoe@instant_messaging_server. Further, the authentication credential may comprise a password used by the user in conjunction with the username to access the instant messaging server 320.

In step 404, the processing system 314 receives the authorization credential and instant messaging identifier from the user of the phone 340. The instant messaging identifier of the user of the phone 340 is identified by the processing system 314 by receiving the information provided by the user of the phone 340.

In an alternative to prompting the user for the instant messaging identifier, the processing system 314 may identify an instant messaging identifier for the user of the phone 340 from other information provided by the user. For example, the instant messaging identifier may be stored in the processing system 314. In response to receiving the information from the user of the phone 340, the processing system 314 may use one or more pieces of the information to locate a instant messaging identifier stored in the processing system 314 by matching one or more fields of the stored instant messaging identifier with one or more pieces of information provided by the user of the phone 340.

In step 406, the processing system 314 authenticates the user of the phone 340 through a prescribed method of authentication. For example, the processing system 314 may store the instant messaging identifier and authorization credentials (e.g., a username and password) for the user in the processing system 314. Upon receiving the instant messaging identifier and authorization credentials from the user of the phone 340, the processing system 314 may check the stored instant messaging identifier and authorization credential records to determine if the instant messaging identifier provided by the user of the phone 340 matches a known instant messaging identifier. If the processing system 314 locates a stored instant messaging identifier matching the instant messaging identifier provided by the user of the phone 340, then the processing system 314 may further determine if a stored authorization credential for the stored instant messaging identifier matches the authorization credential provided by the user of the phone 340. If both the instant messaging identifier and authorization credential provided by the user of the phone 340 match a stored instant messaging identifier and authorization credential, then the user of the phone 340 is correctly authenticated.

In step 408, the processing system 314 may transmit the instant messaging identifier and/or authentication credential to the presence server 322 to authenticate the user of the phone 340 to the presence server 322. The presence server 322 receives the instant messaging identifier and/or authentication credential from the processing system 314, and checks the stored account records of users on the presence server 322 to determine if the user of the phone 340 has an account on the presence server 322. The account records may be based upon the instant messaging identifier. If an account record is found on the presence server 322, then the presence server 322 may further determine if the authentication credential, such as the password, is correct for the user of the phone 340. If the user of the phone 340 is correctly authenticated by the presence server 322, then the presence server 322 may send back an acknowledgment message to the processing system 314 instructing the processing system 314 that the user of the phone 340 has been correctly authenticated. Once the acknowledgment message has been received by the processing system 314 from the presence server 322, then the processing system 314 may provide the user of the phone 340 with a menu comprising at least one status option.

In step 410, in response to the processing system 314 authenticating the user, the interactive voice response system 316 provides a menu to the user of the phone 340 comprising at least one status option. A status option is a status a user can select to be displayed to peer users. For instance, one of the instant messaging status options may comprise an option to change the instant messaging status to “away from desk”.

In step 412, the interactive voice response system 316 receives a selection from the user of one of the status options. For instance, the user of the phone 340 may press “1” to change the instant messaging status to “away from desk”. After receiving the selection from the user, the processing system 314 transmits the update message to the presence server 322.

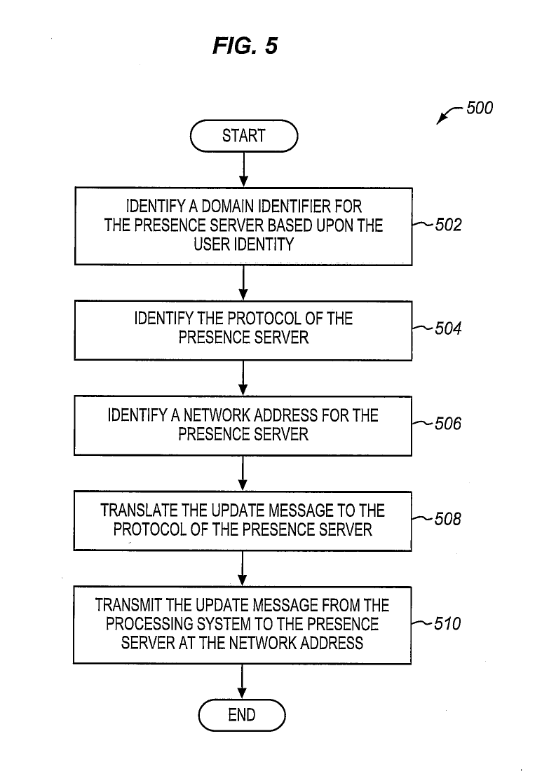

FIG. 5 is a flow chart illustrating a method 500 for determining the identity and location of the presence server 322 in another exemplary embodiment of the invention. The steps of method 500 will be described with reference to FIG. 3. The steps of the flow chart in FIG. 5 are not all inclusive and may include other steps not shown.

In the embodiment described in FIG. 5, the status updating system 300 identifies the particular presence server 322 and the presence server's 322 network location prior to transmitting the update message to the presence server 322. The processing system 314 may use the instant messaging identifier provided by the user to identify a domain identifier and a network address for the presence server 322. For example, the instant messaging identifier may comprise a username jdoe@imserver1 and a password relating to the username.

In step 502, the processing system identifies a domain identifier for the presence server 322 in response to receiving the instant messaging identifier provided by the user of the phone 340. In this instance, the processing system 314 may identify the domain identifier by discarding the contents of the username to the left of the @character, leaving a domain identifier of imserver1. The processing system 314 may identify the user of the phone 340 as a user of an presence server 322 at a domain imserver1.

In step 504, processing system 314 identifies the protocol of presence server 322. The processing system 314 may store in memory the protocols relating to one or more instant messaging servers 320. If the protocols for presence server 322 are not stored in memory, then the processing system 314 may query a server to acquire the protocols.

In step 506, the processing system 314 identifies a network address for the presence server 322 from the domain identifier. In the instance described, the processing system 314 may use a DNS table to determine the network address for imserver1.

In step 508, the processing system 314 translates the update message to the protocol of the presence server 322. For example, the update message may embody an HTTP form request comprising a username for the user, a password for the user, and a numerical selection of an updated instant messaging status message.

In step 510, the processing system 314 transmits the update message through a network to the presence server 322 at the network address. For instance, the update message may be in the form of a SQL statement specifying the selection of at least one status option from the user and the instant messaging identifier for the user desiring to change their instant messaging status on the presence server 322.

In response to receiving the update message, the presence server 322 updates the instant messaging status to reflect the updated instant messaging status requested by the user. Peer users using the peer client application 352 operating on the peer device 340 connected to presence server 322 may receive an update to the “Friends List” specifying the updated instant messaging status of the user.

The status updating system 300 has been described in an embodiment receiving the request from the user through the phone 340. In an alternate embodiment of the invention, status updating system 300 may receive the request to update the instant messaging status of a user on presence server 322 from another type of communication device, such as a PDA having internet capabilities. For instance, the user of the PDA may be provided with a web site for the status updating system 300. The interface system 314 may comprise a web server. The user of the PDA may visit the web site and request a web page comprising a form from the interface system 314. The interface system 314 may provide the form in response to the request for the web page. The form may comprise one or more fields for the user of the PDA to provide his or her instant messaging identifier and authentication credential, such as a username and a password for the instant messaging service on the presence server 322. The form may additionally comprise a menu of at least one status option.

The user of the PDA may complete the form and select at least one status option, and submit the form to the status updating system 300. The status updating system 300 receives the information provided by the user of the PDA in the form using the interface system 314.

The processing system 314 identifies the instant messaging identifier of the user for the presence server 322 in response to receiving the request. In this instance, the processing system 314 may identify the instant messaging identifier for the user of the PDA based upon a username provided by the user of the second device. In response to identifying the instant messaging identifier, the processing system 314 transmits an update message to the presence server 322. The update message is translated by the processing system 314 based upon the selection of at least one status option by the user of the second device, and transmitted to the presence server 322.

Although specific embodiments were described herein, the scope of the invention is not limited to those specific embodiments. The scope of the invention is defined by the following claims and any equivalents thereof.

We claim:

1. A status updating system for updating a user status of a user on a presence server coupled to a communication server adapted to provide a communication service to a client application operating on a client device, wherein the presence server is adapted to monitor the user status of the user for the communication service, the status updating system comprising:
an interface system adapted to receive a request to update the user status on the presence server from a communication device not operating the client application; and
a processing system coupled to the interface system that is adapted to identify a user identifier of the user for the communication service on the communication server in response to the request, and to transmit an update message to the presence server to update the user status for the communication service indicated by the user identifier.

2. The status updating system of claim 1 wherein the processing system is adapted to receive a selection of a status change through the interface system from the user of the communication device, and to transmit the update message to the presence server to update the user status based upon the selection from the user.

3. The status updating system of claim 1 wherein the processing system is further adapted to authenticate the user prior to transmitting the update message to the presence server.

4. The status updating system of claim 1 wherein the processing system is further adapted to prompt the user through the interface system for the user identifier, and to receive information on the user identifier from the user in response to the prompt.

5. The status updating system of claim 1 wherein the processing system is further adapted to receive through the interface system an authentication credential from the user using the communication device, and to transmit the authentication credential to the presence server to authenticate the user of the communication device to the presence server.

6. The status updating system of claim 1 wherein the processing system is further adapted to identify a protocol of the presence server, and to translate the update message to the protocol.

7. The status updating system of claim 1 wherein the interface system comprises an interactive voice response system adapted to receive a phone call from the user through the communication device, to provide a menu to the user comprising at least one status option, to receive a selection from the user of the at least one status option, and to transmit the update message to the presence server to update the user status based upon the selection from the user.

8. The status updating system of claim 1 wherein the communication server comprises an instant messaging server, the communication service comprises an instant messaging service and the presence server monitors an instant messaging status.

9. The status updating system of claim 1 wherein the processing system is further adapted to identify a domain identifier for the presence server based upon the user identifier, to identify a network address of the presence server based on the domain identifier, and to transmit the update message to the presence server at the network address.

10. A method for updating a user status of a user on a presence server coupled to a communication server adapted to provide a communication service to a client application operating on a client device, wherein the presence server is adapted to monitor the user status of the user for the communication service, the method comprising:
receiving a request to update the user status from a communication device not operating the client application;
identifying a user identifier of the user for the communication service in response to the request; and
transmitting an update message to the presence server to update the user status for the communication service indicated by the user identifier.

11. The method of claim 10 further comprising:
receiving a selection of a status change from the user using the communication device; and
transmitting the update message to the presence server to update the user status based on the selection of the user.

12. The method of claim 10 further comprising authenticating the user prior to transmitting the update message to the presence server.

13. The method of claim 10 wherein identifying a user identifier of the user comprises:
prompting the user for the user identifier; and
receiving information on the user identifier from the user in response to the prompt.

14. The method of claim 10 further comprising:
receiving an authentication credential from the user using the communication device; and
transmitting the authentication credential to the presence server to authenticate the user of the communication device to the presence server.

15. The method of claim 10 further comprising:
identifying a protocol for the presence server; and
translating the update message to the protocol.

16. The method of claim 10 wherein receiving a request to update the user status comprises:
receiving a phone call from the user from the communication device;
providing a menu to the user comprising at least one status option;
receiving a selection from the user of the at least one status option from the user using the communication device; and
transmitting an update message to the presence server to update the user status on the presence server based upon the user identifier.

17. The method of claim 10 wherein the communication server comprises an instant messaging server, the communication service comprises an instant messaging service and the presence server monitors an instant messaging status.

18. The method of claim 10 further comprising:
identifying a domain identifier for the presence server based upon the user identifier;
identifying a network address of the presence server based on the domain identifier; and
transmitting the update message to the presence server at the network address.

19. A status updating system for updating an instant messaging status of a user on an instant messaging server adapted to provide an instant messaging service to an instant messaging application operating on a client device and adapted to monitor the instant messaging status of the user for the instant messaging service, the status updating system comprising:
an interface system adapted to receive a request to update the instant messaging status on the instant messaging server from a communication device not operating the instant messaging application; and
a processing system coupled to the interface system that is adapted to identify a instant messaging identifier of the user for the instant messaging service on the instant messaging server in response to the request, and to transmit an update message to the instant messaging server to update the instant messaging status corresponding with the instant messaging identifier on the instant messaging server.

20. The status updating system of claim 19 wherein the interface system is adapted to receive a phone call from the user through the communication device, provide a menu to the user comprising at least one status option, and receive a selection from the user of the at least one status option.
